(19) United States
(12) Patent Application Publication
(10) Pub. No.: US 2019/0052643 A1
(43) Pub. Date: Feb. 14, 2019

(54) CLOUD ACCESS RULE TRANSLATION FOR HYBRID CLOUD COMPUTING ENVIRONMENTS

(71) Applicant: HEWLETT PACKARD ENTERPRISE DEVELOPMENT LP, Houston, TX (US)

(72) Inventors: Parag Doshi, Alpharetta, GA (US); Chandra Kamalakantha, Plano, TX (US); Liem M. Nguyen, Roseville, CA (US); Steve Marney, Pontiac, MI (US); Michael D. Reed, Palo Alto, CA (US); Joshua Griswold, Los Angeles, CA (US)

(21) Appl. No.: 16/076,587

(22) PCT Filed: Feb. 11, 2016
(86) PCT No.: PCT/US2016/017494

§ 371 Date: Aug. 8, 2018

(51) Int. Cl. H04L 29/06; G06N 5/04

(52) U.S. Cl. CPC H04L 63/101; H04L 63/20; H04L 2463/082; H04L 69/08; G06N 5/04; H04L 63/08

(57) ABSTRACT

Examples include cloud access rule translation for a hybrid cloud computing environment. Some examples include translation of a cloud access rule in a cloud-specific format to a canonical format and a determination of whether to allow an application programming interface (API) request for a cloud computing service based on the translated cloud access rule.

### BACKGROUND

Enterprises may use computing systems for a variety of purposes, including for processing, networking, storage, security, and many other uses. In some examples, an enterprise may use its own computing systems, for instance, by obtaining hardware or software. In other examples, an enterprise may utilize hardware or software of a third party provided as a service. For example, an enterprise may use a cloud computing service in which shared computing resources and/or services may be accessed.

### BRIEF DESCRIPTION OF THE DRAWINGS

The following detailed description references the drawings, wherein:

FIG. 1 is a block diagram of an example hybrid cloud authorization service for cloud access rule translation in a hybrid cloud computing environment;

FIG. 2 is a block diagram of an example hybrid cloud authorization service to translate a cloud access rule in a cloud-specific format to a canonical format, determine a suggested cloud access rule, and determine whether to transmit an API request to a cloud computing service in a hybrid cloud computing environment;

FIG. 3 is a block diagram of an example translate engine to translate a cloud access rule in a cloud-specific format to a canonical format;

FIG. 4 is an example block diagram of an example device to determine whether an API function is allowed and to enable or disable an API request of the API function;

FIG. 5 is an example block diagram of an example device to determine whether an API function is allowed, enable or disable an API request of the API function, and determine whether to transmit an API request to a cloud computing service in a hybrid cloud computing environment;

FIG. 6A is a flowchart of an example method including transmitting an API request to a cloud computing service in a hybrid cloud computing environment based on a determination that transmission of the API request is allowed; and

FIG. 6B is a flowchart of an example method including transmitting an error message based on a determination that an API request to a cloud computing service in a hybrid cloud computing environment is not allowed.

### DETAILED DESCRIPTION

As noted above, enterprises may use one or more cloud computing services. A “cloud computing service,” as described herein, allows consumers, such as individual enterprise users, clients, applications, and devices, access to a pool of computing resources, storage resources, and/or networking resources over a network. Cloud computing services may fall into one of several cloud service types, including a public cloud service, a private cloud service, a virtual private cloud service, or a managed cloud service. A “hybrid cloud computing environment,” as described herein, may refer to a combination of two or more cloud service types and may involve multiple cloud computing services.

Cloud computing services may exist to provide varied cloud functions (e.g., resources or services). These cloud computing services may be provided (or hosted) by cloud service providers, also referred to as hosts. Cloud computing services may offer Infrastructure-as-a-Service (laaS) by hosting equipment (i.e., servers, storage components, or networking components, etc.), Software-as-a-Service (SaaS) by hosting applications, Platform-as-a-Service (PaaS) by hosting a computing platform (i.e., operating system(s), hardware, storage, etc.), or any combination thereof. Although several cloud service providers may offer laaS-based cloud services, SaaS-based cloud services, or PaaS-based cloud services, the manner in which these services are provided may differ. For instance, each cloud computing service may offer different application programming interfaces (APIs); different cloud functions having different capabilities provided through the APIs; and different technologies to deliver the different capabilities.

In some examples, different cloud computing services may also offer different access control models to permit access to cloud functions hosted at the cloud. Access may be based on one or more access control models, including, for example, role-based access control (RBAC), attribute-based access control (ABAC), mandatory access control (MAC), and discretionary access control (DAC). Regardless of the access control model used, each cloud computing service may determine access to its cloud functions by way of one or more cloud access policy sets. In some examples, described herein, a cloud access policy set may involve one or more “cloud access rules.” A cloud access rule may help to define whether a consumer is authorized to access one or more cloud functions. Cloud access policy sets and cloud access rules may be stored in authorization templates within a cloud computing service. In some examples, the cloud access policy sets and cloud access rules for a cloud computing service may be in a cloud-specific format that differs from the cloud access policy sets and cloud access rules for another cloud computing service. As described herein, a “cloud-specific format” may be a protocol, language, or standard required by a cloud computing service for defining or storing its cloud access policy sets and cloud access rules. For instance, cloud access rules in HPE Helion® OpenStack are in Javascript® Object Notation (JSON) format. Cloud access rules in VMware vCloud Air® are in a VMware-specific cloud format.

As noted above, a hybrid cloud computing environment may refer to a combination of two or more cloud service types and may involve multiple cloud computing services. For example, in some instances, an enterprise's hybrid cloud computing environment may involve a public cloud (e.g., a public cloud provided by HPE Helion® OpenStack) and a virtual private cloud (e.g., a virtual private cloud provided by VMware vCloud Air®). Accordingly, both the public and private clouds may involve cloud-specific cloud access rules in differing cloud-specific formats.

In such an example, a consumer wishing to access a resource hosted by a particular cloud computing service may request access to the resource via an API request. In some examples, the API request may be received at an API gateway that can authenticate the user and, if appropriate, can route the request to the applicable cloud computing service. While the user may have been authenticated by the API gateway, the cloud computing service may determine whether the user is authorized (i.e., allowed) to access the resource by applying any applicable cloud access rules.

Implementing a global cloud access rule in such an example may involve formatting the rule in each of the cloud-specific formats within the enterprise's hybrid cloud computing environment. Likewise, cataloging, aggregating, or otherwise analyzing cloud access rules across various cloud computing services may involve formatting rules in differing cloud-specific formats to one format. In some such examples, an IT professional at the enterprise or at a hybrid cloud management service may program the global cloud access rule in each of the appropriate cloud-specific formats and/or may program the cloud access rules in each cloud-specific format in a single format. In some examples, the IT professional may program the cloud access rules in each cloud-specific format to a canonical format. In examples described herein, a “canonical format” may refer to a standardized or universal format that allows for communication between different formats.

While a hybrid cloud computing environment may involve programming cloud access rules in several different cloud-specific formats, manual programming of the rules in different cloud-specific formats may introduce undesirable error and result in inefficiencies. In addition, where there is a desire to analyze cloud access rules across clouds, manual programming of the cloud-specific formats to a single format may be unsuitable. It may also be undesirable to perform certain aspects of user authorization at the cloud computing service itself due to cost and other considerations.

Examples described herein may improve access to cloud computing services within a hybrid cloud computing environment. For instance, some examples described herein may utilize a hybrid cloud authorization service for a hybrid cloud computing environment. In such examples, the authorization service may involve translation of cloud access rules from a canonical format to a cloud-specific format and vice versa. Both high-level and fine-grained user authorization can be performed at the authorization service, as desired.

In some examples described herein, a device may provide authorization services for a hybrid cloud computing environment. The device may translate a cloud access rule in a cloud-specific format to a canonical format and store the translated cloud access rule in the canonical format. Upon receiving an API request associated with a cloud computing service in the hybrid cloud computing environment, the device may extract contextual information from the API request and determine whether to apply the translated cloud access rule based on the contextual information. Based on a determination that the translated cloud access rule applies, the device may execute the translated cloud access rule and determine whether to allow or disallow transmission of the API request to the cloud computing service based on the execution of the cloud access rule. In examples described herein, a determination, action, etc., that is said to be “based on” a given condition may be based on that condition alone or based on that condition and other condition(s).

In some examples described herein, a method for providing authorization services for a hybrid cloud computing environment may translate a cloud access rule in a cloud-specific format to a canonical format and store the translated cloud access rule in the canonical format. Upon receiving an API request associated with a cloud computing service in the hybrid cloud computing environment, contextual information may be extracted from the API request. Based on the translated cloud access rule and the contextual information, transmission of the API request may be allowed. Based on the decision that the API request is allowed, the API request may be transmitted to the cloud computing service.

In some examples described herein, a device may register an API for a cloud computing service in a hybrid cloud computing environment. The device may translate a cloud access rule in a cloud-specific format to a canonical format and store the translated cloud access rule in the canonical format. Further, the device may obtain identity information and determine whether an API function is allowed based on the identity information and the translated cloud access rule. Based on a determination that the API function is allowed, the device may provide information to enable an API request of the API function via an interface. Based on a determination that the API function is not allowed, the device may provide information to disable an API request of the API function via the interface.

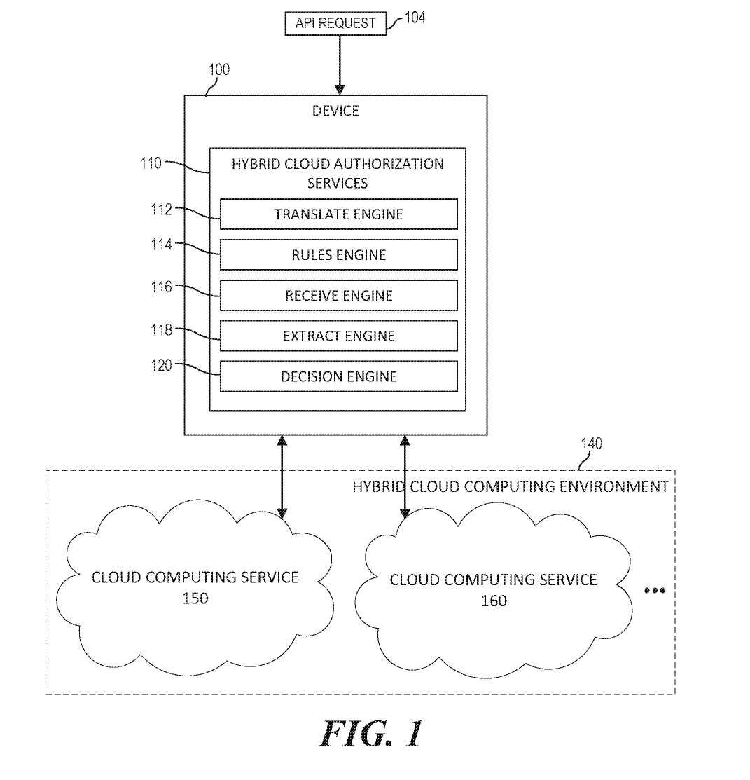

Referring now to the drawings, FIG. 1 is a block diagram of an example device that provides “hybrid cloud authorization services”, which as described herein, allow for access to cloud computing services in a hybrid cloud computing environment. A “hybrid cloud computing environment,” as described herein, may refer to a combination of two or more cloud service types and may involve multiple cloud computing services.

Device 100 may be any networking or computing device suitable for execution of the functionality described below. As used herein, a “device” may be a desktop computer, laptop (or notebook) computer, workstation, tablet computer, mobile phone, smart device, switch, router, server, blade enclosure, or any other processing device or equipment including a processing resource. In some examples, device 100 may be any networking or computing device that includes an API gateway.

In the example of FIG. 1, device 100 includes hybrid cloud authorization services 110. Hybrid cloud authorization services 110 may be implemented at least in part by engines 112, 114, 116, 118, and 120, which may be any combination of hardware and programming to implement the functionalities of the engines described herein.

In some examples, device 100 may communicate via a computer network (e.g., Internet, Local Area Network (LAN), Wide Area Network (WAN), etc.) with cloud computing services 150 and 160 within a hybrid cloud computing environment 140. Although two cloud computing services 150 and 160 are illustrated in FIG. 1, in examples described herein, a hybrid cloud computing environment may involve any suitable number of cloud computing services (encompassing at least two cloud service types). Cloud computing services may allow consumers, such as individual enterprise users, clients, applications, and devices, access to a pool of computing resources, storage resources, and/or networking resources over a network. A cloud computing service may offer different cloud types such as a public cloud service, a private cloud service, a virtual private cloud service, or a managed cloud service. In some examples, cloud computing service 150 can be one cloud type, such as a public cloud, and cloud computing service 160 can be a different cloud type, such as a virtual private cloud. Cloud computing services 150 and 160 can have different cloud-specific formats. A “cloud-specific format,” as described herein, may involve a protocol, language, or standard required by a cloud-computing service for defining or storing its cloud access policy sets and cloud access rules.

A translate engine 112 may receive a cloud access rule in a cloud-specific format and may translate it. In the examples described herein, a “cloud access rule” may help to define whether a consumer is authorized to access one or more cloud functions. Translate engine 112 may request and receive the cloud access rule in the cloud-specific format from a database of cloud access rules such as an authorization template within a cloud computing service. In other examples, translate engine 112 may receive the cloud access rule in the cloud-specific format from an enterprise administrator or an owner of the associated cloud service or resource. After receiving the cloud access rule in the cloud-specific format, translate engine 112 translates the cloud access rule to a canonical format. In examples described herein, a “canonical format” may refer to a standardized or universal format that allows for communication between different formats. As an example, the eXtensible Access Control Markup Language (XACML) may be considered a canonical format. In some examples, translate engine 112 may dynamically translate the cloud access rule in the doud-specific format to the canonical format upon receiving the cloud access rule in the cloud-specific format.

Translate engine 112 may also receive a cloud access rule in a canonical format and may translate it to a cloud-specific format. For example, translate engine 112 may request and receive the cloud access rule in the canonical format from a database of cloud access rules such as a rules engine, described in more detail below. In other examples, translate engine 112 may receive the cloud access rule in the canonical format from an enterprise administrator or an owner of the associated cloud service or resource. After receiving the cloud access rule in the canonical format, translate engine 112 can translate the cloud access rule to a cloud-specific format. In some examples, if the cloud access rule is to apply to each cloud computing service within a hybrid cloud computing environment, translate engine 112 may translate the cloud access rule to the cloud-specific format for each cloud-computing service. The translated cloud-specific cloud access rules can be stored within the appropriate cloud computing service. If the cloud access rule is only to apply to certain cloud computing services within a hybrid cloud computing environment, translate engine 112 may translate the cloud access rule to only the applicable cloud-specific formats. In some examples, translate engine 112 may dynamically translate the cloud access rule in the canonical format to the cloud-specific format upon receiving the cloud access rule in the canonical format.

A rules engine 114 may receive and store the translated cloud access rule in the canonical format. In some examples, rules engine 114 may be a database or other storage mechanism suitable for storing cloud access rules in canonical format. Rules engine 114 may receive and store a cloud access rule in a canonical format from a database of cloud access rules and/or may receive and store a cloud access rule in a canonical format from an enterprise administrator or an owner of the associated cloud service or resource. Rules engine 114 may also be populated by a hybrid cloud authorization services administrator.

A receive engine 116 may receive (e.g., obtain, intercept) an API request 104 and provide API request 104 to an extract engine, discussed in more detail below. An API may specify a set of functions or routines that facilitate interfacing and communication with a cloud function within a cloud computing service. An “API request,” as described herein, may represent a requested operation, function, or routine performed by or at the cloud function within a cloud computing service. For instance, an API request may involve an API call or a selected unified resource locator (URL). In some examples, receive engine 116 may intercept and thus receive API request 104 sent to, for example, one of cloud computing services 150 and 160, from a consumer. In other examples, an application on device 100 may intercept API request 104 sent to, for example, one of cloud computing services 150 and 160. In such examples, receive engine 116 may request and receive or otherwise obtain API request 104 from device 100.

An extract engine 118 may receive API request 104 from receive engine 116 and extract contextual information from it. In the examples described herein, “contextual information” may refer to information related to the context of the API request. For example, contextual information may comprise information relating to the cloud computing service, the cloud function (including its location), the operation or action to be taken, the identity of the consumer, the location of the consumer, the nature of the device from which the API request originated, the time of the API request, etc.

Based (at least in part) on the contextual information extracted by extract engine 118, a decision engine 120 determines whether to apply the translated cloud access rule in the canonical format stored in rules engine 114 to API request 104. In some examples, decision engine 120 may receive or access the translated cloud access rule in rules engine 114. In such examples, decision engine 120 may compare the contextual information with the translated cloud access rule to determine the rule's applicability. For instance, if the contextual information and the translated cloud access rule both identify a particular cloud function, decision engine 120 may determine that the translated cloud access rule should be applied to API request 104.

Based (at least in part) on a determination that the translated cloud access rule applies, decision engine 120 may execute the translated cloud access rule. Decision engine 120 may determine whether to allow or disallow transmission of the API request to the appropriate cloud computing service based (at least in part) on the execution of the translated cloud access rule. Execution of the translated cloud access rule can indicate whether a consumer is or is not allowed to access a cloud function and/or perform an action identified in API request 104.

In some examples, based (at least in part) on the contextual information from API request 104, decision engine 120 may determine that two or more cloud access rules within rules engine 114 apply. In such examples, the cloud access rules may include a translated cloud access rule and/or a non-translated cloud access rule stored in rules engine 114. Based (at least in part) on the determination that the cloud access rules apply, decision engine 120 may execute the cloud access rules and based (at least in part) on the execution of the rules, determine whether to allow or disallow transmission of the API request to the appropriate cloud computing service.

In other examples, decision engine 120 may determine that no cloud access rule within rules engine 114 applies to API request 104. In such examples, based on the contextual information of the API request 104 or other factors, decision engine 120 may determine to allow transmission of API request 104 for authorization at the appropriate cloud computing service. In other such examples, based on the contextual information of the API request 104 or other factors, decision engine 120 may determine to disallow transmission of API request 104.

Hybrid cloud authorization services 110 may be implemented by at least one device and may include at least engines 112, 114, 116, 118, and 120, which may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of hybrid cloud authorization services 110. In some examples, the at least one machine-readable storage medium may store instructions that, when executed by the at least one processing resource, at least partially implement some or all engines of hybrid cloud authorization services 110. In such examples, hybrid cloud authorization services 110 may include the at least one machine-readable storage medium storing the instructions and the at least one processing resource to execute the instructions.

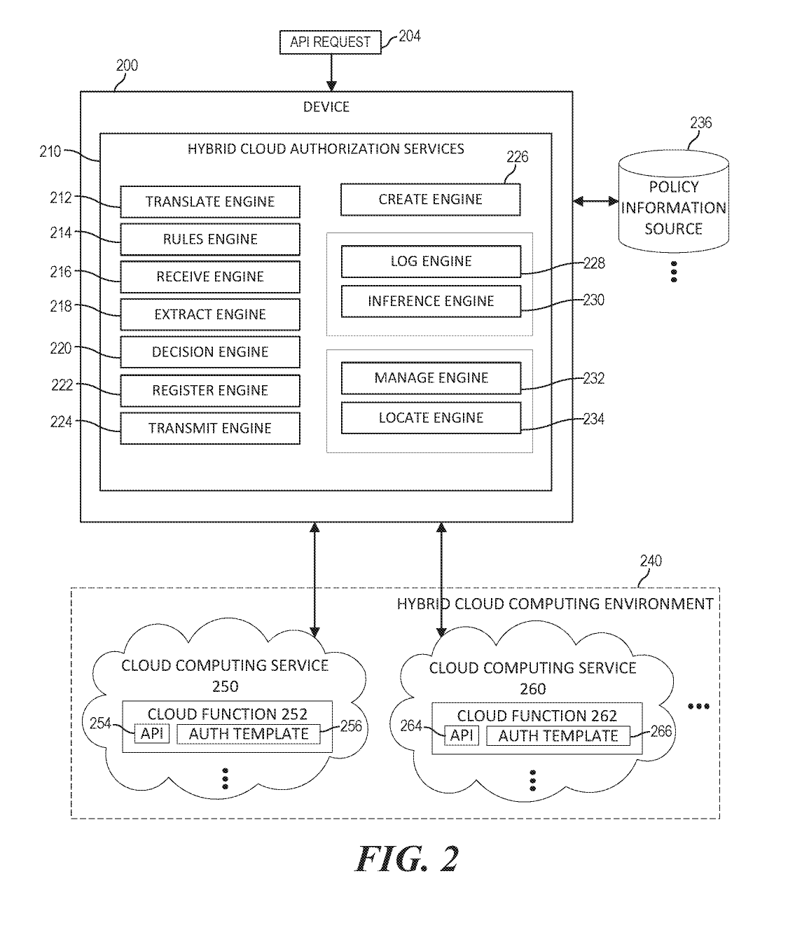

In some examples, the instructions can be part of an installation package that, when installed, can be executed by the at least one processing resource to at least partially implement at least some of the engines of hybrid cloud authorization services 110. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on device 100 including the processing resource. In such examples, the machine-readable storage medium may include memory such as a hard drive, solid state drive, or the like. In other examples, the functionalities of any engines of hybrid cloud authorization services 110 may be at least partially implemented in the form of electronic circuitry. In some examples, functionalities described herein in relation to FIG. 1 may be provided in combination with functionalities described herein in relation to any of FIGS. 2-6.

Further examples are described herein in relation to FIG. 2, which is a block diagram of an example device that provides hybrid cloud authorization services for a hybrid cloud computing environment to register an API, translate a cloud access rule in a cloud-specific format to a canonical format, and determine whether to allow or disallow access to cloud computing services in a hybrid cloud computing environment. Device 200 may be any networking or computing device suitable for execution of the functionality described below. In some examples, device 200 may be any networking or computing device that includes an API gateway. In the example of FIG. 2, device 200 includes hybrid cloud authorization services 210. Hybrid cloud authorization services 210 may be implemented at least in part by engines 212, 214, 216, 218, 220, 222, 224, 226. 228, 230, 232, and 234, which may be any combination of hardware and programming to implement the functionalities of the engines described herein.

In some examples, device 200 may communicate via a computer network with cloud computing services 250 and 260 within a hybrid cloud computing environment 240. Although two cloud computing services 250 and 260 are illustrated in FIG. 2, in examples described herein, a hybrid cloud computing environment may involve any suitable number of cloud computing services (encompassing at least two cloud service types). Cloud computing services may allow consumers, such as individual enterprise users, clients, applications, and devices, access to a pool of computing resources, storage resources, and/or networking resources over a network. A cloud computing service may offer different cloud types such as a public cloud service, a private cloud service, a virtual private cloud service, or a managed cloud service. In some examples, cloud computing service 250 can be one cloud type, such as a public cloud, and cloud computing service 260 can be a different cloud type, such as a virtual private cloud. Cloud computing services 250 and 260 can have different cloud-specific formats.

Each cloud computing service 250 and 260 may offer a cloud function 252 and 262, respectively. A cloud function may refer to a resource or service hosted by the cloud computing service. For example, cloud functions may involve cloud compute, cloud object storage, cloud block storage, cloud identity, cloud domain name service (DNS), and many others. Although two cloud functions 252 and 262 are illustrated in FIG. 2, in examples described herein, cloud computing services such as 250 and 260 may involve any suitable number of cloud functions. For each cloud function, a cloud computing service may provide an API such as API 254 for cloud function 252 and API 264 for cloud function 262. An API may specify a set of functions or routines that facilitate interfacing and communication with a cloud function within a cloud computing service. Each cloud function 252 and 262 may also be associated with an authorization template 256 and 266, respectively, for organizing and storing cloud access rules in the cloud-specific format of cloud computing service 250 and 260, respectively. In some examples, authorization templates 256 and 266 may be a database or other storage mechanism suitable for storing cloud access rules in the cloud-specific format of the cloud computing service with which they are associated. While a single API and authorization template are illustrated for each cloud computing service, in examples described herein, cloud computing services such as 250 and 260 may involve any suitable number of APIs and authorization templates.

As illustrated in FIG. 2, in some examples, hybrid cloud authorization services 210 may involve a register engine 222. Register engine 222 may register an API for a cloud computing service, i.e., cloud computing service 250 or 260, in the hybrid cloud computing environment 240. In some examples, registration may involve discovery of cloud computing services within a hybrid cloud computing environment, discovery of APIs associated with the cloud computing services, importation of discovered APIs, and registration of the imported APIs within hybrid cloud authorization services 210. In other examples, registration may involve accessing APIs at device 200 or a hybrid cloud management service, and registering the APIs within hybrid cloud authorization services 210. In some examples, register engine 222 may dynamically register APIs as new APIs become available.

A translate engine 212 may receive a cloud access rule in a cloud-specific format and may translate it. In some examples, translate engine 212 may request and receive the cloud access rule in the cloud-specific format from a database of cloud access rules, e.g., authorization templates 256 and 266 within cloud computing services 250 and 260. In other examples, translate engine 212 may receive the cloud access rule in the cloud-specific format from an enterprise administrator or an owner of the associated cloud service or resource. After receiving the cloud access rule in the cloud-specific format, translate engine 212 can translate the cloud access rule to a canonical format. In some examples, translate engine 212 may dynamically translate the cloud access rule in the cloud-specific format to the canonical format upon receiving the cloud access rule in the cloud-specific format.

Translate engine 212 may also receive a cloud access rule in a canonical format and may translate it to a cloud-specific format. Translate engine 212 may request and receive the cloud access rule in the canonical format from a database of cloud access rules such as a rules engine. In other examples, translate engine 212 may receive the cloud access rule in the canonical format from an enterprise administrator or an owner of the associated cloud service or resource. After receiving the cloud access rule in the canonical format, translate engine 212 can translate the cloud access rule to a cloud-specific format, if desired. In some examples, if the cloud access rule is to apply to each cloud computing service within a hybrid cloud computing environment, translate engine 212 may translate the cloud access rule to the cloud-specific format for each cloud-computing service. The cloud-specific cloud access rules can be stored within the appropriate cloud computing service. If the cloud access rule is only to apply to certain cloud computing services within a hybrid cloud computing environment, translate engine 212 may translate the cloud access rule to only the applicable cloud-specific formats. In some examples, translate engine 212 may dynamically translate the cloud access rule in the canonical format to the cloud-specific format upon receiving the cloud access rule in the canonical format.

A rules engine 214 may receive and store the translated cloud access rule in the canonical format. In some examples, rules engine 214 may be a database or other storage mechanism suitable for storing cloud access rules in canonical format. Rules engine 214 may receive a cloud access rule in a canonical format from a database of cloud access rules and/or may receive a cloud access rule in a canonical format from an enterprise administrator or an owner of the associated cloud service or resource. Rules engine 214 may also be populated by a hybrid cloud authorization service administrator. In yet other examples, rules engine 214 may receive a cloud access rule in a canonical format from a create engine 226.

In some examples, create engine 226 may receive cloud access rule information from a hybrid cloud management interface to create a cloud access nrule in a canonical format. As described herein, “cloud access rule information” may comprise any information used to create a cloud access rule. In such examples, a hybrid cloud management interface may allow an enterprise administrator, owner of a cloud service or resource, or other authorized customer or consumer to input cloud access rule information for creation of a cloud access rule. In some examples, the hybrid cloud management interface may be a graphical user interface. One such hybrid management interface may prompt an authorized customer to complete various fields relating to, for example, cloud function, cloud action, and authorized consumers. Another such hybrid management interface may prompt an authorized customer to complete a series of binary queries (e.g., yes or no) relating to, for example, cloud function, cloud action, and authorized consumers. Input information may be received by create engine 226 as cloud access rule information.

Create engine 226 may receive the cloud access rule information from the hybrid cloud management interface and create the cloud access rule in the canonical format. In some examples, create engine 226 may compare the cloud access rule information against a rule creation database to create the cloud access rule in the canonical format. After creating the cloud access rule in the canonical format, create engine 226 may send the cloud access rule to rules engine 214, which may store the cloud access rule in the canonical format. In some examples, create engine 226 may dynamically create and send the cloud access rule in the canonical format to rules engine 214. In such examples, rules engine 214 may dynamically store the cloud access rule.

A receive engine 216 may receive (e.g., obtain, intercept) an API request 204 and provide API request 204 to an extract engine. In some examples, receive engine 216 may intercept and thus receive API request 204 sent to, for example, one of cloud computing services 250 and 260 within hybrid cloud computing environment 240, from a consumer. In other examples, an application on device 200 may intercept API request 204 sent to, for example, one of cloud computing services 250 and 260. In such examples, receive engine 216 may request and receive or otherwise obtain API request 204 from device 200.

An extract engine 218 may receive API request 204 from receive engine 216 and extract contextual information from it. Based (at least in part) on the contextual information extracted by extract engine 218, a decision engine 220 determines whether to apply the translated cloud access rule in the canonical format stored in rules engine 214 to API request 204. In some examples, decision engine 220 may receive or access the translated cloud access rule in rules engine 214. In such examples, decision engine 220 may compare the contextual information with the translated cloud access rule to determine the rule's applicability. For instance, if the contextual information and the translated cloud access rule both identify a particular cloud function, decision engine 220 may determine that the translated cloud access rule should be applied to API request 204.

Based (at least in part) on a determination that the translated cloud access rule applies, decision engine 220 may execute the translated cloud access rule. In some examples, to execute the translated cloud access rule and/or determine whether to allow or disallow transmission of the API request to the cloud computing service, decision engine 220 may determine whether to access a policy information source 236 based (at least in part) on the translated cloud access rule and the contextual information. In the examples described herein, a “policy information source” may refer to any source that includes policy information. In some examples, policy information source 236 may be a database or otherstorage mechanism suitable for storing policy information at any suitable location. In such examples, a policy information source may comprise one or more of resource management information, resource availability information, financial information, and compliance information. As an example, a policy information source may comprise resource availability and/or financial information located at an enterprise. In another example, a policy information source may comprise compliance information, involving, e.g., regulatory compliance information, data provenance compliance information, service-level agreement (SLA) compliance information, and/or architecture compliance information, etc., located at their original sources of origin. In such examples, policy information may be federated and the policy information source(s) dynamically accessed.

Decision engine 220 may determine whether to allow or disallow transmission of the API request to the appropriate cloud computing service based (at least in part) on the execution of the translated cloud access rule. In some examples, execution of the translated cloud access rule may indicate that the consumer is allowed to access a cloud function and/or perform an action identified in API request 204. In some examples, execution of the translated cloud access rule and/or a determination whether to allow or disallow transmission of the API request to the computing service may involve determining whether to access policy information source 236.

In some examples, based (at least in part) on the contextual information from API request 204, decision engine 220 may determine that two or more cloud access rules within rules engine 214 apply. In such examples, the cloud access rules may include a translated cloud access rule and/or a non-translated cloud access rule stored in rules engine 214. Based (at least in part) on the determination that the cloud access rules apply, decision engine 220 may execute the cloud access rules and based (at least in part) on the execution of the rules, determine whether to allow or disallow transmission of the API request to the appropriate cloud computing service.

In other examples, decision engine 220 may determine that no cloud access rule within rules engine 214 applies to API request 204. In such examples, based on the contextual information of the API request 204, policy information source 236, or other factors, decision engine 220 may determine to allow transmission of API request 204 for authorization at the appropriate cloud computing service. In other such examples, based on the contextual information of the API request 204, policy information source 236, or other factors, decision engine 220 may determine to disallow transmission of API request 204.

Based (at least in part) on a decision to allow transmission of API request 204 to one of cloud computing services 250 or 260, in some examples, transmit engine 224 may receive API request 204 from decision engine 220 and may transmit API request 204 to the appropriate cloud computing service. In such examples, transmit engine 224 may transmit API request 204 to the appropriate cloud computing service by sending API request 204 to device 200 to transmit or by directly sending API request to cloud computing service 250 or 260. In some examples, transmit engine 224 may receive information of a decision not to allow transmission of API request 204 to one of cloud computing services 250 or 260. In some such examples, transmit engine may transmit an error message to the consumer or device 200. The error message may indicate to the consumer that the API request was not allowed or the error message may be an error code.

As further illustrated in FIG. 2, in some examples, hybrid cloud authorization services 210 may involve a log engine 228 and an inference engine 230. Log engine 228 may log and store API request 204, the contextual information from API request 204, and the determination whether to allow or disallow transmission of API request 204. Log engine 228 can also log and store other suitable or desired information. In some examples, log engine 228 may be a database or other storage mechanism suitable for logging and storing the API request, the contextual information, and the determination whether to allow or disallow transmission.

Inference engine 230 may apply logical rules, including analytics, to the logged and stored API request, contextual information, and determination whether to allow or disallow transmission (and any other logged and stored information) to determine a suggested cloud access rule. In such examples, the logged and stored API request, contextual information, and determination upon which inference engine 230 may apply logical rules may include a complete, historical set or some subset of the API requests, contextual information, and the determinations at hybrid cloud authorization services 210. In some examples, inference engine 230 may dynamically monitor and dynamically apply logical rules to the information logged and stored in log engine 228 to dynamically determine suggested cloud access rules. In some examples, the suggested cloud access rules may automatically be stored in rules engine 214. In other examples, the suggested cloud access rules can be transmitted to an enterprise administrator or owner of a cloud service or resource for approval before storage in rules engine 214. As an example, if consumers A, B, and C, having certain characteristics and financial assets above a certain amount are allowed access to a particular cloud resource per a cloud access rule, inference engine 230, after monitoring and/or applying logical rules to the historical information in log engine 228, may suggest a cloud access rule that allows consumer D, having similar characteristics and financial assets, also be allowed access to the cloud resource.

In some examples, when API request 204 does not specify a location of a resource to be accessed, hybrid cloud authorization services 210 may involve a manage engine 232 and a locate engine 234. Manage engine 232 may manage the location of the resource associated with API request 204. Manage engine 232 may dynamically maintain a resource and resource provider (e.g., cloud computing service) mapping to allow location identification for a resource. Manage engine 232 may additionally maintain a mapping of APIs that can operate on the resource. In some examples, manage engine 232 may store and/or retrieve mapped information from a resource database or other storage mechanism suitable for storing the information. Maintaining or mapping a resource's location may involve tracking whether the resource is in a data center or hypervisor, tracking its geographic region, and/or tracking its availability zone within data center regions. In such examples, manage engine 232 may dynamically track a resource and its location or may receive location information from the resource database or a resource tracking system. Manage engine 232 may also dynamically discover resources or may receive resource discovery information from the resource database or a resource discovery system.

Locate engine 234 may locate a resource associated with the API request via manage engine 232. In some examples, locate engine 234 may access or query manage engine 232 to determine the location of a requested resource. Locate engine 234 may send the location to transmit engine 224 for transmission of API request 204 to the appropriate cloud computing service location. Locate engine 234 may also, in some examples, receive key information associated with a resource's location from a global key management service. In such examples, a consumer may be granted unique keys to access resources or services at different locations within a cloud. The global key management service may obtain and map these unique keys per consumer. Locate engine 234 may receive and send the key information to transmit engine 224 for transmission of the key with API request 204 to the appropriate cloud computing service location.

Hybrid cloud authorization services 210 may be implemented by at least one device and may include at least engines 212, 214, 216, 218, 220, 222, 224, 226, 228, 230, 232, and 234, which may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of hybrid cloud authorization services 210. In some examples, the at least one machine-readable storage medium may store instructions that, when executed by the at least one processing resource, at least partially implement some or all engines of hybrid cloud authorization services 210. In such examples, hybrid cloud authorization services 210 may include the at least one machine-readable storage medium storing the instructions and the at least one processing resource to execute the instructions.

In some examples, the instructions can be part of an installation package that, when installed, can be executed by the at least one processing resource to at least partially implement at least some of the engines of hybrid cloud authorization services 210. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on device 200 including the processing resource. In such examples, the machine-readable storage medium may include memory such as a hard drive, solid state drive, or the like. In other examples, the functionalities of any engines of hybrid cloud authorization services 210 may be at least partially implemented in the form of electronic circuitry. In some examples, functionalities described herein in relation to FIG. 2 may be provided in combination with functionalities described herein in relation to any of FIGS. 1 and 3-6.

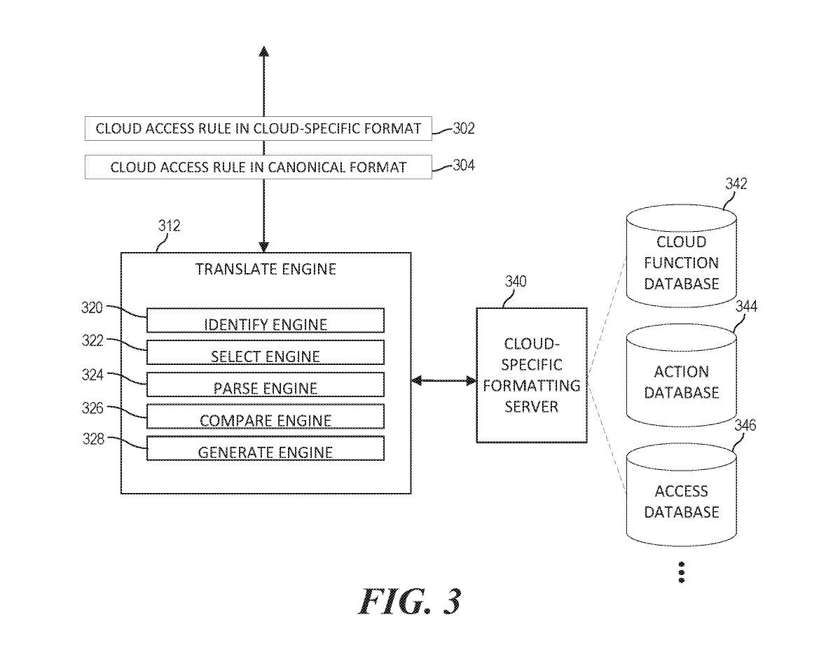

FIG. 3 is a block diagram of an example translate engine to translate a cloud access rule in a cloud-specific format to a canonical format. In some examples, translate engine 312 may also be used to translate a cloud access rule in a canonical format to a cloud-specific format. Translate engine 312 may be implemented at least in part by engines 320, 322, 324, 326, and 328, which may be any combination of hardware and programming to implement the functionalities of the engines described herein.

An identify engine 320 may receive a cloud access rule in a cloud-specific format 302 and identify the cloud-specific format for translation. In some examples, identify engine 320 may analyze the syntax or formatting of the cloud access rule to identify the cloud-specific format. In other examples, identify engine 320 may determine the cloud computing service associated with the cloud access rule (via, e.g., the cloud function or other identifying factors) to identify the cloud-specific format of the corresponding cloud computing service. Identify engine 320 may provide the identified cloud-specific format to select engine 322. In some examples, identify engine 320 may receive a cloud access rule in a canonical format 304, identify the canonical format for translation, and provide the identified canonical format to select engine 322.

Select engine 322 may select a canonical format to which cloud access rule in the cloud-specific format 302 should be translated and may select a cloud-specific formatting server 340 based on the cloud-specific format identified by identify engine 320. In some examples, select engine 322 may select a canonical format based on the capabilities of the hybrid cloud authorization services with which it is associated and/or an input from a hybrid cloud authorization services administrator. In some examples, select engine 322 may select a doud-specific format to which cloud access rule in the canonical format 304 should be translated and may select a canonical formatting server based on the canonical format identified by identify engine 320.

Parse engine 324 may parse cloud access rule in the cloud-specific format 302. In some examples, parse engine 324 may parse the cloud access rule into a cloud function portion, an action portion, and an access portion. The cloud function portion may indicate the cloud resource or service to which the cloud access rule may apply; the action portion may indicate the action (i.e., delete, create, store, etc.) to be taken with respect to the cloud function portion; and the access portion may indicate the consumers that may or may not be allowed access. Parse engine 324 can parse the cloud access rule into any other portion that may facilitate translation of the cloud access rule. For example, in some instances, parse engine 324 may parse or abstract out a logical operator portion or location portion of the cloud access rule. In some examples, parse engine 324 may send the parsed cloud function portion, action portion, and access portion (along with any other parsed portions) to compare engine 326. In some examples, parse engine 324 may also parse cloud access rule in the canonical format 304 into a cloud function portion, an action portion, and an access portion and send the parsed portions to compare engine 326.

Compare engine 326 may compare the portions of the cloud access rule parsed by parse engine 324 against cloud-specific formatting server 340. As illustrated in FIG. 3, cloud-specific formatting server 340 may store or provide access to cloud function database 342, action database 344, and access database 346. Cloud-specific formatting server 340 may be any server, database, or other suitable storage mechanism capable of storing or providing access to a cloud function database 342, an action database 344, and an access database 346. In some examples, cloud-specific formatting server 340 may itself comprise a database and cloud function database 342, action database 344, and access database 346 may comprise tables or other storage structures within the database. Cloud-specific formatting server 340 may store any other databases that may facilitate translation of the cloud access rule. For example, in some instances, cloud-specific formatting server 340 may store a logical operator database or a location database. The stored databases may relate to the information necessary or helpful to complete a translation and/or the parsed portions of the cloud access rule per parse engine 324.

Cloud-specific formatting server 340 and cloud function database 342, action database 344, and access database 346 may be located in any suitable location for access by compare engine 326. In some examples, cloud-specific formatting server 340 may be located at the hybrid authorization services, for example, hybrid authorization services 110 or 210. In other examples, cloud-specific formatting server 340 may be located elsewhere on the device on which the hybrid authorization services reside, for example, device 100 or 200. In yet other examples, cloud-specific formatting server 340 may be located external to the device.

Compare engine 326 may compare each portion of cloud access rule in the cloud-specific format 302 to a corresponding database to map the portion of the rule in the cloud-specific format to the canonical format. In some examples, compare engine 326 may compare the cloud function portion of cloud access rule in cloud-specific format 302 against a cloud function database 342 and map the cloud function portion to the selected canonical format. Compare engine 326 may compare the action portion of cloud access rule in the cloud-specific format 302 against an action database 344 and map the action portion to the selected canonical format. Compare engine 326 may compare the access portion of cloud access rule in the cloud-specific format 302 against an access database and map the access portion to the selected canonical format. In some examples, compare engine 326 may compare other portions of cloud-specific rule in cloud-specific format 302 against corresponding databases. In such examples, compare engine 326 may compare a logical operator portion against a logical operator database and map the logical operator portion to the canonical format. After mapping the portions to the canonical format, in some examples, compare engine 326 may send the mappings to a generate engine 328. In some examples, compare engine 326 may also compare portions of cloud access rule in the canonical format against corresponding databases in a canonical formatting database and map the portions of the rule to the cloud-specific format.

Generate engine 328 may receive mapped portions in the canonical format from compare engine 326 and generate a cloud access rule in the canonical format. In some examples, generating the cloud access rule in the canonical format may involve arranging or ordering the mapped portions in the canonical format according to a syntax or format specific to the canonical format. In some examples, generate engine 328 may also receive mapped portions in the cloud-specific format from compare engine 326 and generate a cloud access rule in the cloud-specific format.

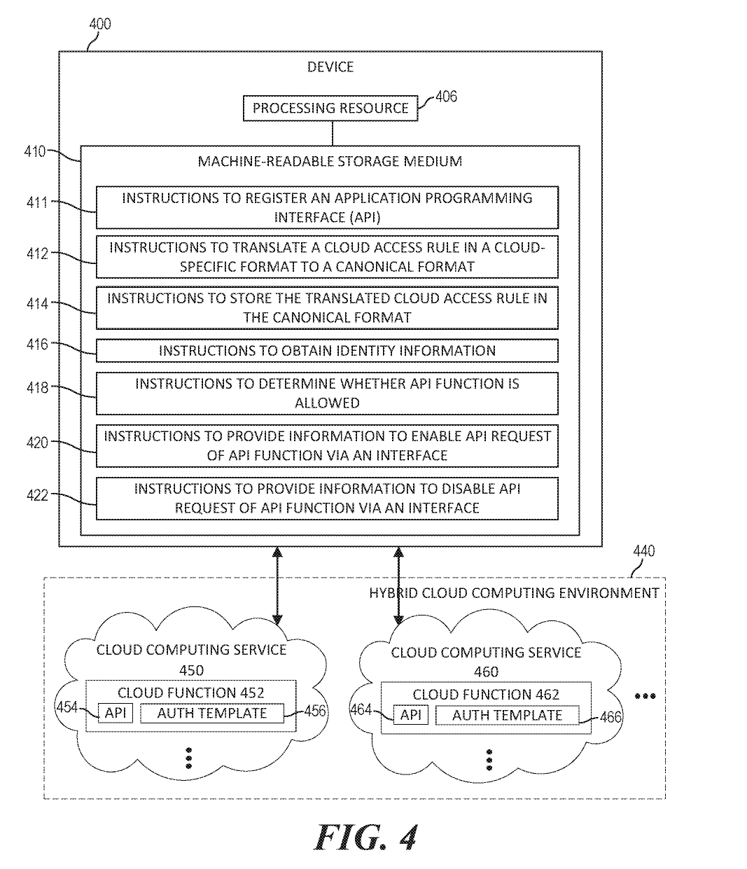

FIG. 4 is an example block diagram of an example device to determine whether an API function is allowed and to enable or disable an API request of the API function. Device 400 includes a processing resource 406 and a machine-readable storage medium 410 comprising (e.g., encoded with) instructions 411, 412, 414, 416, 418, 420, and 422 executable by processing resource 406 to implement functionalities described herein in relation to FIG. 4. In some examples, storage medium 410 may include additional instructions. In other examples, the functionalities described herein in relation to instructions 411, 412, 414, 416, 418, 420, 422, and any additional instructions described herein in relation to storage medium 410, may be implemented at least in part in electronic circuitry (e.g., via engines comprising any combination of hardware and programming to implement the functionalities of the engines, as described above). Device 400 may be any networking or computing device suitable for execution of the functionality described below.

In some examples, device 400 may communicate via a computer network with cloud computing services 450 and 460 within a hybrid cloud computing environment 440. Although two cloud computing services 450 and 460 are illustrated in FIG. 4, in examples described herein, a hybrid cloud computing environment may involve any suitable number of cloud computing services (encompassing at least two cloud service types). Cloud computing services may allow consumers, such as individual enterprise users, clients, applications, and devices, access to a pool of computing resources, storage resources, and/or networking resources over a network. A cloud computing service may offer different cloud types such as a public cloud service, a private cloud service, a virtual private cloud service, or a managed cloud service. In some examples, cloud computing service 450 can be one cloud type, such as a public cloud, and cloud computing service 460 can be a different cloud type, such as a virtual private cloud. Cloud computing services 450 and 460 can have different cloud-specific formats.

Each cloud computing service 450 and 460 may offer a cloud function 452 and 462, respectively. A cloud function may refer to a resource or service hosted by the cloud computing service. For example, cloud functions may involve cloud compute, cloud object storage, cloud block storage, cloud identity, cloud domain name service (DNS), and many others. Although two cloud functions 452 and 462 are illustrated in FIG. 4, in examples described herein, cloud computing services such as 450 and 460 may involve any suitable number of cloud functions. For each cloud function, a cloud computing service may provide an API such as API 454 for cloud function 452 and API 464 for cloud function 462. An API may specify a set of functions or routines that facilitate interfacing and communication with a cloud function within a cloud computing service. Each cloud function 452 and 462 may also be associated with an authorization template 456 and 466, respectively, for organizing and storing cloud access rules in the cloud-specific format of cloud computing service 450 and 460, respectively. In some examples, authorization templates 456 and 466 may be a database or other storage mechanism suitable for storing cloud access rules in the cloud-specific format of the cloud computing service with which they are associated. While a single API and authorization template are illustrated for each cloud computing service, in examples described herein, cloud computing services such as 450 and 460 may involve any suitable number of APIs and authorization templates.

A cloud function may be accessed via an API request. An “API request,” as described herein, may represent a requested operation, function, or routine performed by or at the cloud function within a cloud computing service. For instance, an API request may involve an API call or a selected unified resource locator (URL). Each API request may have an associated function, or API function. As described herein, an “API function” may indicate the operation, function, or routine to be performed by or at the cloud function and requested in an API request.

In the example of FIG. 4, instructions 411 may receive and register an API for a cloud computing service, i.e., cloud computing service 450 or 460, in the hybrid cloud computing environment 440. In some examples, registration may involve discovery of cloud computing services within a hybrid cloud computing environment, discovery of APIs associated with the cloud computing services, importation of discovered APIs, and registration of the imported APIs in machine-readable storage medium 410. In other examples, registration may involve accessing APIs at device 400 or a hybrid cloud management service, and registering the APIs in machine-readable storage medium 410. In some examples, instructions 411 may dynamically register APIs as new APIs become available. In addition, in some examples, instructions 411 may register an API for a cloud computing service as described above in relation to register engine 222 in FIG. 2.

Instructions 412 may receive a cloud access rule in a cloud-specific format and translate it. In some examples, instructions 412 may request and receive the cloud access rule in the cloud-specific format from a database of cloud access rules, e.g., authorization templates 456 and 466 within cloud computing services 450 and 460. In other examples, the cloud access rule in the cloud-specific format may be received from an enterprise administrator or an owner of the associated cloud service or resource. After receiving the cloud access rule in the cloud-specific format, the cloud access rule can be translated to a canonical format. In some examples, instructions 412 may dynamically translate the cloud access rule in the cloud-specific format to the canonical format upon receiving the cloud access rule in the cloud-specific format. In addition, in some examples, instructions 412 may implement the functionality discussed above in relation to translate engine 212 in FIG. 2 and/or translate engine 312 in FIG. 3.

Instructions 414 may receive and store the translated cloud access rule in the canonical format in a database or other storage mechanism suitable for storing cloud access rules in canonical format. In some examples, a cloud access rule in a canonical format may be received from a database of cloud access rules. In other examples, instructions 414 may receive and store a cloud access rule in a canonical format from an enterprise administrator, an owner of the associated cloud service or resource, ora hybrid cloud authorization services administrator. In addition, in some examples, instructions 414 may store the translated cloud access rule as described above in relation to rules engine 214 in FIG. 2.

Instructions 416 may obtain identity information associated with a consumer. In some examples, a consumer wishing to access a cloud service or resource may be authenticated (i.e., the consumer's identity is verified) by device 400 or any other suitable device. For instance, in some such examples, authentication may be managed by an identity management process in an API gateway product. Instructions 416 may request and receive or otherwise access identity information associated with a consumer from device 400 or any device at which the identity information may be located. In some examples, instructions 416 may determine whether to use a multifactor authentication. As described in the examples herein, “multifactor authentication” may involve verifying a consumer's identity using more than one method of authentication. Methods of authentication may involve a password, a pin, a security token, biometrics, and many other such methods. In such examples, instructions 416 may determine to use multifactor authentication based on, for example, the API function or the particular type of consumer (e.g., mobile application, web application, etc.). Based on a determination to use multifactor authentication, instructions 416 may access an authentication provider. As described herein, an “authentication provider” may refer to any provider of an authentication method for use in multifactor authentication. The authentication provider may authenticate the consumer and provide identity information associated with the consumer.

Based (at least in part) on the identity information and the translated cloud access nrule, instructions 418 may determine whether an API function is allowed. In some examples, instructions 418 may determine, based on the identity information, whetherto apply the translated cloud access rule. In such examples, instructions 418 may compare the identity information with the translated cloud access rule to determine the rule's applicability. In one example, if the identity information and the translated cloud access rule both identify a particular consumer, instructions 418 may determine that the translated cloud access rule should be applied and executed. If the cloud access rule allows the consumer access to a particular cloud function, or access to certain actions with respect to a particular cloud function, instructions 418 may allow the corresponding API functions.

Based (at least in part) on a determination that an API function is allowed, instructions 420 may provide information to enable an API request of the API function via an interface. In some examples, instructions 420 may provide information relating to allowed API functions for a particular consumer to an interface at which the consumer may request the API function via an API request. In such examples, the interface may be a display interface such as a graphical user interface (GUI) that allows the consumer to select URLs or network links to allowed API functions. In other examples, instructions 420 may provide information relating to allowed API functions for a particular consumer to any other device or application capable of enabling API requests of the API functions via an interface.

Based (at least in part) on a determination that an API function is not allowed, instructions 422 may provide information to disable an API request of the API function via an interface. In some examples, instructions 422 may provide information relating to disallowed API functions for a particular consumer to an interface at which the consumer may attempt to request the API function via an API request. In such examples, the interface may be a display interface such as a GUI that allows the consumer to select URLs or network links to allowed API functions, but does not allow the consumer to select URLs or network links to disallowed API functions by, for instance, removing the links or making the links otherwise inoperable. In other examples, instructions 422 may provide information relating to disallowed API functions for a particular consumer to any other device or application capable of disabling API requests of the API functions via an interface.

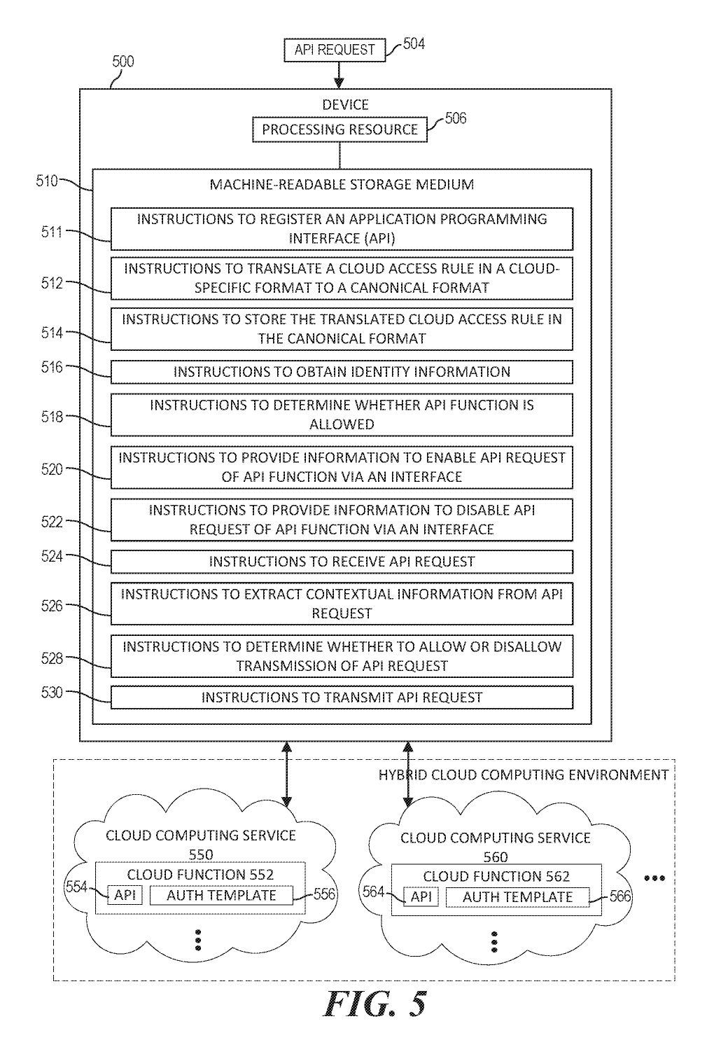

FIG. 5 is an example block diagram of an example device to determine whether an API function is allowed, enable or disable an API request of the API function, and determine whether to transmit an API request to a cloud computing service in a hybrid cloud computing environment. Device 500 includes a processing resource 506 and a machine-readable storage medium 510 comprising (e.g., encoded with) instructions 511, 512, 514, 516, 518, 520, 522, 524, 526, 528, and 530 executable by processing resource 506 to implement functionalities described herein in relation to FIG. 5. In some examples, storage medium 510 may include additional instructions. In other examples, the functionalities described herein in relation to instructions 511, 512, 514, 516, 518, 520, 522, 524, 526, 528, 530, and any additional instructions described herein in relation to storage medium 510, may be implemented at least in part in electronic circuitry (e.g., via engines comprising any combination of hardware and programming to implement the functionalities of the engines, as described above). Device 500 may be any networking or computing device suitable for execution of the functionality described below.

In some examples, device 500 may communicate via a computer network with cloud computing services 550 and 560 within a hybrid cloud computing environment 540. Although two cloud computing services 550 and 560 are illustrated in FIG. 5, in examples described herein, a hybrid cloud computing environment may involve any suitable number of cloud computing services (encompassing at least two cloud service types). Cloud computing services may allow consumers, such as individual enterprise users, clients, applications, and devices, access to a pool of computing resources, storage resources, and/or networking resources over a network. A cloud computing service may offer different cloud types such as a public cloud service, a private cloud service, a virtual private cloud service, or a managed cloud service. In some examples, cloud computing service 550 can be one cloud type, such as a public cloud, and cloud computing service 560 can be a different cloud type, such as a virtual private cloud. Cloud computing services 550 and 560 may have different cloud-specific formats.

Each cloud computing service 550 and 560 may offer a cloud function 552 and 562, respectively. A cloud function may refer to a resource or service hosted by the cloud computing service. For example, cloud functions may involve cloud compute, cloud object storage, cloud block storage, cloud identity, cloud domain name service (DNS), and many others. Although two cloud functions 552 and 562 are illustrated in FIG. 5, in examples described herein, cloud computing services such as 550 and 560 may involve any suitable number of cloud functions. For each cloud function, a cloud computing service may provide an API such as API 554 for cloud function 552 and API 564 for cloud function 562. An API may specify a set of functions or routines that facilitate interfacing and communication with a cloud function within a cloud computing service. Each cloud function 552 and 562 may also be associated with an authorization template 556 and 566, respectively, for organizing and storing cloud access rules in the cloud-specific format of cloud computing service 550 and 560, respectively. In some examples, authorization templates 556 and 566 may be a database or other storage mechanism suitable for storing cloud access rules in the cloud-specific format of the cloud computing service with which they are associated. While a single API and authorization template are illustrated for each cloud computing service, in examples described herein, cloud computing services such as 550 and 560 may involve any suitable number of APIs and authorization templates. A cloud function may be accessed via an API request. Each API request may have an associated API function.

Instructions 511 may register an API, as described above in relation to instructions 411 in FIG. 4. Instructions 512 may translate a cloud access rule in a cloud-specific format to a translated cloud access rule in a canonical format, as described above in relation to instructions 412 in FIG. 4. Instructions 514 may store the translated cloud access rule in the canonical format, as described above in relation to instructions 414 in FIG. 4. Instructions 516 may obtain identity information, as described above in relation to instructions 416 in FIG. 4. Instructions 518 may determine whether an API function is allowed based on the identity information and the translated cloud access rule, as described above in relation to instructions 418 in FIG. 4. Instructions 520 may provide information to enable an API request of the API function based on a determination that the API function is allowed, as described above in relation to instructions 420 in FIG. 4. Instructions 522 may provide information to disable the API request of the API function based on a determination that the API function is not allowed, as described above in relation to instructions 422 in FIG. 4.

Instructions 524 may receive (e.g., obtain, intercept) an enabled API request 504. In some examples, instructions 524 may intercept and thus receive API request 504 sent to, for example, one of cloud computing services 550 and 560 within hybrid cloud computing environment 540, from a consumer. In some examples, an application on device 500 may intercept API request 504 sent to, for example, one of cloud computing services 550 and 560. In such examples, instructions 524 may request and receive or otherwise obtain API request 504 from device 500. In addition, in some examples, instructions 524 may receive the enabled API request as described above in relation to receive engine 216 in FIG. 2.

Instructions 526 may extract contextual information from enabled API request 504. In some examples, instructions 526 may extract contextual information from enabled API request 504 as described above in relation to extract engine 218 in FIG. 2. Instructions 528 may determine whether to allow or disallow transmission of the API request based on the translated cloud access rule in the canonical format and the contextual information. Based (at least in part) on the contextual information, instructions 528 may determine whether to apply the translated cloud access rule in the canonical format to enabled API request 504. Instructions 528 may compare the contextual information with the translated cloud access rule to determine the rule's applicability. For instance, if the contextual information and the translated cloud access rule both identify a particular cloud function, instructions 528 may determine that the translated cloud access rule should be applied to enabled API request 504. Based (at least in part) on a determination that the translated cloud access rule applies, instructions 528 may execute the translated cloud access rule and determine whether to allow or disallow transmission of enabled API request 504 to the appropriate cloud computing service based (at least in part) on the execution of the translated cloud access rule.

Based (at least in part) on determining that the enabled API request is allowed, instructions 530 may transmit the enabled API request to the cloud computing service. Instructions 530 may transmit enabled API request 504 to the appropriate cloud computing service by sending enabled API request 504 to device 500 to transmit or by directly sending API request to cloud computing service 550 or 560.

In examples described herein, a “processing resource” may include, for example, one processor or multiple processors included in a single device or distributed across multiple devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 406 of FIG. 4 may fetch, decode, and execute instructions stored on storage medium 410, to perform the functionalities described above in relation to instructions 411, 412, 414, 416, 418, 420, and 422. Likewise, processing resource 506 of FIG. 5 may fetch, decode, and execute instructions stored on storage medium 510, to perform the functionalities described above in relation to instructions 511, 512, 514, 516, 518, 520, 522, 524, 526, 528, and 530. In some such examples, any or all of the instructions of storage medium 410 and 510, respectively, may be part of a plug-in application or applications, capable of being downloaded and installed by processing resource 406 and 506, respectively. In other examples, the functionalities of any of the instructions of storage medium 410 and 510 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the examples of FIGS. 4 and 5, storage medium 410 and 510, respectively, may each be implemented by one machine-readable storage medium, or multiple machine-readable storage media.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

In some examples, instructions 411, 412, 414, 416, 418, 420, and 422 of FIG. 4 and instructions 511, 512, 514, 516, 518, 520, 522, 524, 526, 528, and 530 of FIG. 5, may be part of an installation package that, when installed, may be executed by processing resource 406 and 506, respectively, to implement the functionalities described above. In such examples, storage medium 410 and 510 may be a portable medium, such as a CD, DVD, or flash drive, or a memory maintained by a server from which the installation package can be downloaded and installed. In other examples, instructions 411, 412, 414, 416, 418, 420, and 422 of FIG. 4 and instructions 511, 512, 514, 516, 518, 520, 522, 524, 526, 528, and 530 of FIG. 5 may be part of a plug-in application or applications, capable of being downloaded and installed on device 400 and 500, respectively, by processing resource 406 and 506, respectively. In yet other examples, instructions 411, 412, 414, 416, 418, 420, and 422 of FIG. 4 and instructions 511, 512, 514, 516, 518, 520, 522, 524, 526, 528, and 530 of FIG. 5 may be part of an application, applications, or component(s) already installed on device 400 and 500, respectively, including processing resource 406 and 506, respectively. In such examples, the storage medium 410 and 510 may include memory such as a hard drive, solid state drive, or the like. In some examples, functionalities described herein in relation to either of FIGS. 4 and 5 may be provided in combination with functionalities described herein in relation to any of FIGS. 1-3 and 6.

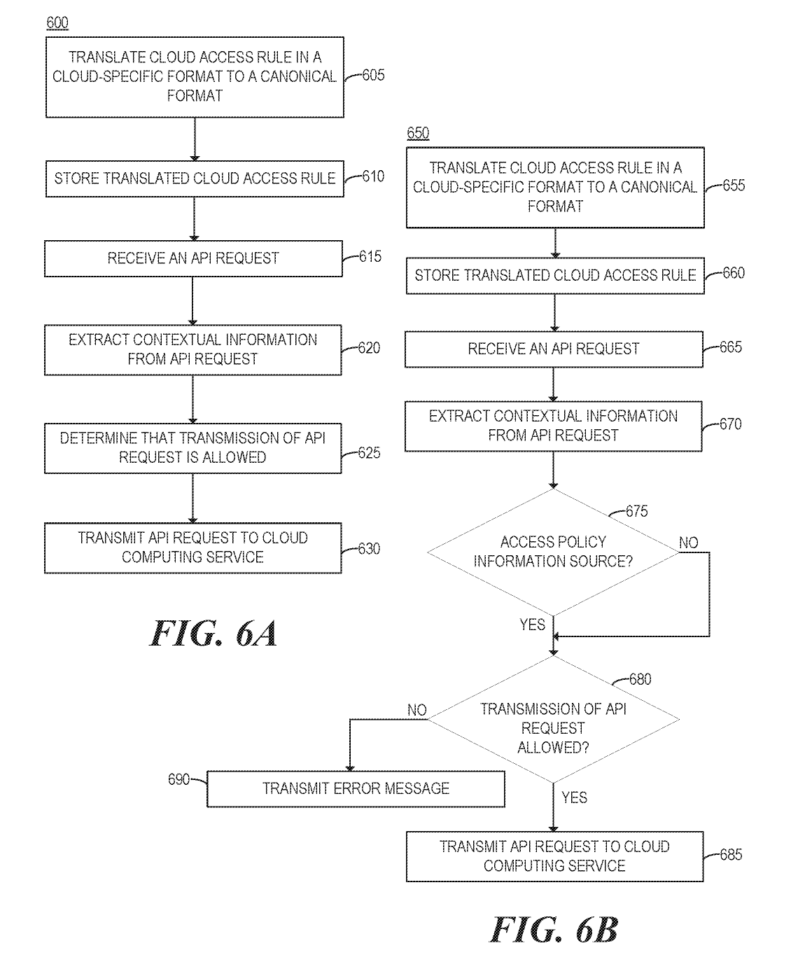

FIG. 6A is a flowchart of an example method 600 including transmitting an API request to a cloud computing service in a hybrid cloud computing environment based on a determination that transmission of the API request is allowed. Although execution of method 600 is described below with reference to device 200 of FIG. 2, other suitable systems for the execution of method 600 can be utilized (e.g., device 100 of FIG. 1). Additionally, implementation of method 600 is not limited to such examples.

In the example of FIG. 6A, method 600 may be a method of device 200. At 605 of method 600, translate engine 212 may translate a cloud access rule in a cloud-specific format to a translated cloud access rule in a canonical format. This translation may be performed as described above in relation to translate engine 212 of FIG. 2. This translation may additionally be performed as described above in relation to translate engine 312 of FIG. 3.

At 610, rules engine 214 may store the translated cloud access rule in the canonical format, as described above in relation to rules engine 214 of FIG. 2. At 615, receive engine 216 may receive an API request associated with a cloud computing service in the hybrid cloud computing environment, as described above in relation to receive engine 216 of FIG. 2. At 620, extract engine 218 may extract contextual information from the API request, as described above in relation to extract engine 218 of FIG. 2. At 625, decision engine 220 may determine that transmission of the API request is allowed based on the translated cloud access rule in the canonical format and the contextual information, as described above in relation to decision engine 220 of FIG. 2. At 630, transmit engine 224 may transmit the API request to the cloud computing service based on a decision that transmission of the API request is allowed.

Although the flowchart of FIG. 6A shows a specific order of performance of certain functionalities, method 600 is not limited to that order. For example, the functionalities shown in succession in the flowchart may be performed in a different order, may be executed concurrently or with partial concurrence, or a combination thereof. In some examples, functionalities described herein in relation to FIG. 6A may be provided in combination with functionalities described herein in relation to any of FIGS. 1-5 and 6B.

FIG. 6B is a flowchart of an example method 650 including transmitting an error message based on a decision that transmission of an API request to a cloud computing service in a hybrid cloud computing environment is not allowed. Although execution of method 650 is described below with reference to device 200 of FIG. 2, other suitable systems for the execution of method 650 can be utilized (e.g., device 100 of FIG. 1). Additionally, implementation of method 650 is not limited to such examples.

In the example of FIG. 6B, method 650 may be a method of device 200. At 655 of method 650, translate engine 212 may translate a cloud access rule in a cloud-specific format to a translated cloud access rule in a canonical format. This translation may be performed as described above in relation to translate engine 212 of FIG. 2. This translation may additionally be performed as described above in relation to translate engine 312 of FIG. 3.

At 660, rules engine 214 may store the translated cloud access rule in the canonical format, as described above in relation to rules engine 214 of FIG. 2. At 665, receive engine 216 may receive an API request associated with a cloud computing service in the hybrid cloud computing environment, as described above in relation to receive engine 216 of FIG. 2. At 670, extract engine 218 may extract contextual information from the API request, as described above in relation to extract engine 218 of FIG. 2.

At 675, decision engine 220 may determine whether to access a policy information source 236 based on the translated cloud access rule in the canonical format and the contextual information. This determination may be performed as described above in relation with decision engine 220 of FIG. 2. Whether it is determined to access policy information source 236 or not, method 650 may proceed to 680. If a determination is made to access policy information source 236, policy information source 236 may be accessed and method 650 may proceed to 680. At 680, decision engine 220 may determine whether transmission of the API request is allowed or not allowed based on the translated cloud access rule in the canonical format and the contextual information, as described above in relation to decision engine 220 of FIG. 2. If it is determined that transmission of the API request is allowed, method 650 may proceed to 685, where transmit engine 224 may transmit the API request to the cloud computing service, as described above in relation to transmit engine 224 of FIG. 2. If it is determined that transmission of the API request is not allowed, method 650 may proceed to 690, where transmit engine 224 may transmit an error message, as described above in relation to transmit engine 224 of FIG. 2.

Although the flowchart of FIG. 6B shows a specific order of performance of certain functionalities, method 650 is not limited to that order. For example, the functionalities shown in succession in the flowchart may be performed in a different order, may be executed concurrently or with partial concurrence, or a combination thereof. In some examples, functionalities described herein in relation to FIG. 6B may be provided in combination with functionalities described herein in relation to any of FIGS. 1-6A.

1. A device to provide hybrid cloud authorization services for a hybrid cloud computing environment, comprising:
a non-transitory computer-readable storage medium comprising instructions representing a translate engine, a rules engine, a receive engine, an extract engine, and a decision engine;
a processor configured to execute the instructions;
the translate engine to translate a cloud access rule in a cloud-specific format to a translated cloud access rule in a canonical format;
the rules engine to store the translated cloud access rule in the canonical format;
the receive engine to receive an application programming interface (API) request associated with a cloud computing service in the hybrid cloud computing environment;
the extract engine to extract contextual information from the API request; and
the decision engine to determine whether to apply the translated cloud access rule in the canonical format based on the contextual information, to execute the translated cloud access rule in the canonical format based on a determination that the translated cloud access rule in the canonical format applies, and to determine whether to allow or disallow transmission of the API request to the cloud computing service based on the execution of the translated cloud access rule in the canonical format.

2. The device of claim 1, the decision engine further to:
determine whether to access a policy information source based on the translated cloud access rule in the canonical format and the contextual information, wherein the policy information source comprises an information source for at least one of resource management information, resource availability information, financial information, and compliance information.

3. The device of claim 1, further comprising:
a register engine to register an API for the cloud computing service in the hybrid cloud computing environment; and
a transmit engine to transmit the API request to the cloud computing service based on a decision to allow transmission of the request.

4. The device of claim 1, the translate engine further to:
translate a cloud access rule from the canonical format to the cloud-specific format.

5. The device of claim 1, wherein the translate engine receives the cloud access rule in the cloud-specific format from an authorization template in the cloud computing service and further comprises:
the instructions of the non-transitory computer-readable storage medium further representing an identify engine, a select engine, a parse engine, a compare engine, and a generate engine
the identify engine to identify the cloud-specific format of the cloud access rule in the cloud-specific format,
the select engine to select a canonical format and to select a cloud-specific formatting server based on the cloud-specific format and the canonical format,
the parse engine to parse the cloud access rule in the cloud-specific format into a cloud function portion, an action portion, and an access portion,
the compare engine to:
compare the cloud function portion of the cloud access rule in the cloud-specific format against a cloud function database in the cloud-specific formatting server and map the cloud function portion to the canonical format,
compare the action portion of the cloud access rule in the cloud-specific format against an action database in the cloud-specific formatting server and map the action portion to the canonical format,
compare the access portion of the cloud access rule in the cloud-specific format against an access database in the cloud-specific formatting server and map the access portion to the canonical format, and
the generate engine to generate a cloud access rule in the canonical format.

6. The device of claim 1, the rules engine further to:
receive a cloud access rule in the canonical format from a create engine wherein the create engine receives cloud access rule information from a hybrid cloud management interface and creates the cloud access rule in the canonical format; and
store the cloud access rule in the canonical format

7. The device of claim 1, further comprising:
the instructions of the non-transitory computer-readable storage medium further representing a log engine and an interference engine;
the log engine to log and store the API request, the contextual information from the API request, and the determination whether to allow or disallow transmission of the API request; and
the inference engine to apply logical rules to the logged and stored API request, contextual information, and determination to determine a suggested cloud access rule.

8. The device of claim 1, further comprising:
the instructions of the non-transitory computer-readable storage medium further representing a manage engine and a locate engine;
the manage engine to manage a location of a resource associated with the API request; and
the locate engine to locate a resource associated with the API request via the manage engine wherein the API request does not specify the location of the resource.

9. A method of a device for providing hybrid cloud authorization services for a hybrid cloud computing environment, comprising:
translating, by the device, a cloud access rule in a cloud-specific format to a canonical format;
storing, by the device, the translated cloud access rule in the canonical format;
receiving, by the device, an application programming interface (API) request associated with a cloud computing service in the hybrid cloud computing environment;
extracting, by the device, contextual information from the API request;
determining, by the device, that transmission of the API request is allowed based on the translated cloud access rule in the canonical format and the contextual information; and
transmitting, by the device, the API request to the cloud computing service based on a determination that the transmission is allowed.

10. The method of claim 9 wherein deciding that transmission of the API request is allowed further comprises:
determining whether to access a policy information source based on the translated cloud access rule in the canonical format and the contextual information.

11. The method of claim 9 further comprising:
translating, by the device, a cloud access rule from the canonical format to the cloud-specific format.

12. The method of claim 190 further comprising:
transmitting, by the device, an error message based on a determination that the transmission of the API request is not allowed.

13. An article comprising at least one non-transitory machine-readable storage medium comprising instructions executable by a processing resource of a device to:
register an application programming interface (API) for a cloud computing service in a hybrid cloud computing environment;
translate a cloud access rule in a cloud-specific format to a canonical format;
store the translated cloud access rule in the canonical format;
obtain identity information;
determine whether an API function is allowed based on the identity information and the translated cloud access rule;
based on a determination that the API function is allowed, provide information to enable an API request of the API function via an interface; and
based on a determination that the API function is not allowed, provide information to disable the API request of the API function via the interface.

14. The article of claim 13 wherein the instructions further comprise instructions to:
receive the enabled API request to the cloud computing service;
extract contextual information from the enabled API request;
determine whether to allow or disallow transmission of the enabled API request based on the translated cloud access rule in the canonical format and the contextual information; and
transmit the enabled API request to the cloud computing service based on a determination that the transmission is allowed.

15. The article of claim 13 wherein the instructions to obtain identity information further comprise instructions to:
determine whether to use a multifactor authentication; and
access an authentication provider based on a determination to use multifactor authentication.
